(19) United States
(12) Patent Application Publication
(10) Pub. No.: US 2023/0154243 A1
(43) Pub. Date: May 18, 2023

(54) METHOD FOR NOTIFYING OF AN ABNORMAL EVENT AND SELF-PROPELLED DEVICE AND NOTIFICATION SYSTEM FOR IMPLEMENTING THE SAME

(71) Applicant: ALL RING TECH CO., LTD., KAOHSIUNG CITY (TW)

(72) Inventor: Hung-Ju CHOU, KAOHSIUNG CITY (TW)

(21) Appl. No.: 18/046,498

(22) Filed: Oct. 13, 2022

(30) Foreign Application Priority Data
Nov. 16, 2021 (TW) 110142514

(51) Int. Cl. G07C 5/00; G08B 21/18; G05D 1/02

(52) U.S. Cl. CPC G07C 5/008; G08B 21/18; G05D 1/0276; G06F 3/14

(57) ABSTRACT

The invention provides a method for notifying of an abnormal event and a self-propelled device and a notification system for implementing the same. The method for notifying of an abnormal event includes: providing a self-propelled device having a sensor and an internal computer; providing a terminal device having a display; controlling the self-propelled device to use the sensor and the internal computer to establish map information in a workspace; outputting a notification message by the internal computer when an abnormal event happens to the self-propelled device; and displaying the notification information by the display, in which the notification information includes the map information and a marking pattern in the map information, and the marking pattern indicates a corresponding position of the self-propelled device in the workspace, and thereby reducing the time cost to find the self-propelled device for the operator.

### RELATED APPLICATIONS

This application claims priority to Taiwan Application Serial Number 110142514 filed Nov. 16, 2021, which is herein incorporated by reference.

### BACKGROUND

### Technical Field

The invention relates to a method for notifying of an abnormal event and a self-propelled device and a notification system for implementing the same, and more particularly to a method for notifying an operator of an abnormal event during the movement of a self-propelled device and the self-propelled device and a notification system for implementing the same.

### Description of Related Art

Simultaneous localization and mapping (SLAM) technology has been widely used in conventional self-propelled devices. The self-propelled device may traverse the workspace first, so that a structural feature of the workspace can be obtained by a sensor on the front side of the self-propelled device scanning a physical structure of the workspace. Then, the structural features are combined into map information having a map structure by a graph-building algorithm. Finally, the self-propelled device plans the working path to perform work such as cleaning, inspection, transportation, etc., in accordance with the map information.

As moving automatically in the workspace, the self-propelled device may encounter many unpredictable abnormal events, such as a collision event, a hardware abnormality event, an obstacle blocking event, etc., during the work performed in the workspace. If an abnormal event triggers a protection mechanism of the self-propelled device, which will stop moving and waiting for the operator to remove the abnormal event. While an abnormal event happens, the self-propelled device can usually notify the operator to go to the location of the incident.

However, the workspace may be a different site or floor of a large factory and store. The operator cannot immediately know where the self-propelled device is located after arriving at the workspace, and the operator still needs to take a while to find the self-propelled device in the workspace. It can be seen that there is still room for improvement in the method for notifying of an abnormal event of the known self-propelled devices.

### SUMMARY

Thus, the purpose of the invention is to provide a method for notifying of an abnormal event that can reduce the time cost to find a self-propelled device for the operators.

Another purpose of the invention is to provide the self-propelled device for implementing the method for notifying of an abnormal event.

Another purpose of the invention is to provide the notification system for implementing the method for notifying of an abnormal event.

According to the purpose of the invention, the method for notifying of an abnormal event including: providing a self-propelled device having a sensor and an internal computer; providing a terminal device having a display and built-in communication software; controlling the self-propelled device to use the sensor and the internal computer to establish map information in a workspace, wherein the map information corresponds to the workspace; outputting a notification information by the internal computer when an abnormal event happens in the self-propelled device; displaying the notification information in a communication group of the communication software by the display, in which the notification information includes the map information and a marking pattern in the map information, and the marking pattern indicates a corresponding position of the self-propelled device in the workspace.

According to another purpose of the invention, the self-propelled device is used to implement the method for notifying of an abnormal event.

According to another purpose of the invention, the notification system is used to implement the method for notifying of an abnormal event.

The method for notifying of an abnormal event and the self-propelled device and the notification system for implement the same in according with the embodiment of the invention, while an abnormal event happens to the self-propelled device in the workspace, the notification information is displayed on the display of the terminal device, so that a corresponding position of the self-propelled device in the workspace can be interpreted by the operator. Therefore, the time for the operator to find the self-propelled device can be reduced.

### BRIEF DESCRIPTION OF THE DRAWINGS

FIG. 1 is a diagram of a notification system in an embodiment of the invention.

FIG. 2 is a diagram of a self-propelled device in an embodiment of the invention.

FIG. 3 is a diagram of a terminal device in an embodiment of the invention.

FIG. 4 is a diagram of the self-propelled device scanning the workspace in the workspace according to an embodiment of the invention.

FIG. 5 is a diagram of map information corresponding to a workspace in an embodiment of the invention.

FIG. 6 is a diagram of displaying notification information on a terminal device according to an embodiment of the invention.

FIG. 7 is a diagram of displaying notification information on a terminal device according to an embodiment of the invention.

### DETAILED DESCRIPTION

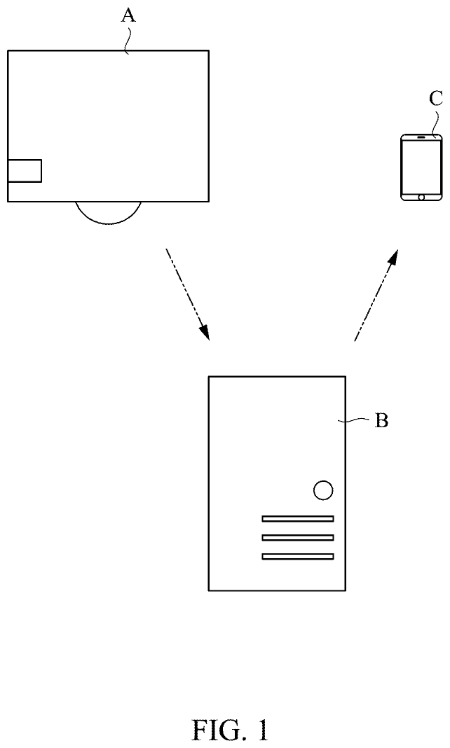

Referring to FIG. 1, the method for notifying of an abnormal event can be achieved by using the notification system in accordance with an embodiment of the invention as shown in the figure, and a self-propelled device A, an external computer B and a terminal device C are disposed in the notification system; the notification information may be outputted to the external computer B by the self-propelled device A, which is processed and stored by the external computer B and then outputted to the terminal device C.

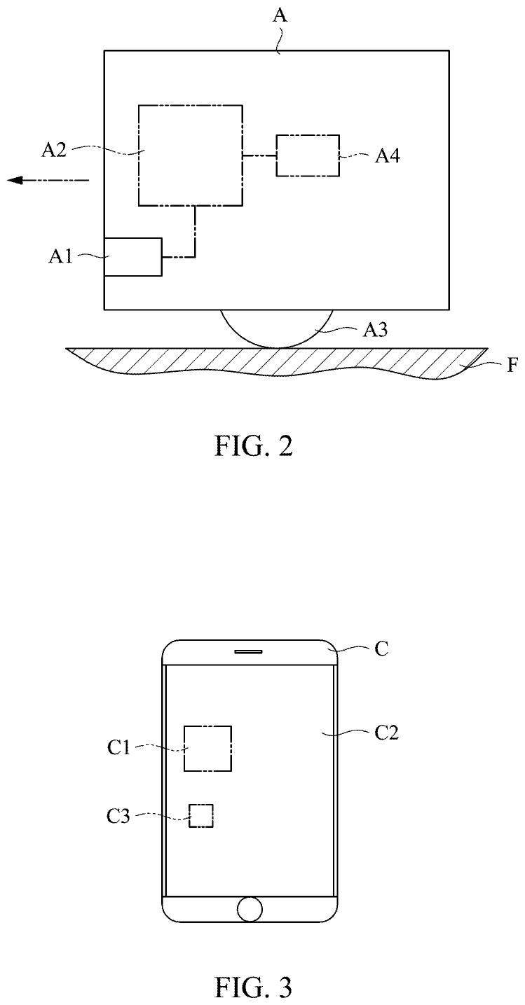

Referring to FIG. 1 and FIG. 2, the self-propelled device A is provided having a sensor A1, an internal computer A2, a drive unit A3 and a controller A4; the sensor A1 is disposed on the front side of the self-propelled device A and has a predetermined scanning direction and range. The sensor A1 can be implemented by one of common sensors that can obtain structural features, for example, a LIDAR, a camera, a video camera, an infrared sensor, an ultrasonic sensor, etc., or combinations thereof. The internal computer A2 has functions such as processing, storing, and transmitting information. The internal computer A2 can process the structural features into map information through various algorithms, and then store it or wirelessly transmit the notification information to the external computer B outside the self-propelled device A. The algorithm can be, for example, one of common algorithms in simultaneous localization and map information construction (Simultaneous localization and mapping; SLAM) technologies, such as a Triangulation algorithm, a Kalman Filter algorithm, a Particle Filter algorithm, a Monte Carlo Localization (MCL) algorithm, a Mixture MCL algorithm, a Markov Localization (Grid-Based Markov) algorithm, etc., or combinations thereof; The wireless transmission can be implemented by one of common wireless transmission technologies such as a 4G/5G transmission technology, a Bluetooth transmission technology, a WIFI transmission technology, a ZigBee transmission technology, etc., or combination thereof. The driving unit A3 is disposed on the lower side of the self-propelled device A, and the driving unit A3 can drive the self-propelled device A to perform actions such as forward, backward, rotating, etc., on a work surface F; the controller A4 can perform various functions of the self-propelled device A, such as controlling the action of the drive unit A3, etc.

Referring to FIG. 1 and FIG. 2, the external computer B has functions such as processing, storing, and transmitting information. The notification information is transmitted from the internal computer A2 of the self-propelled device A to the external computer for reception. After processing the notification information into a format that is easy for operators to interpret and then stored or wirelessly transmitted to the terminal device C; the external computer B can be, for example, one of the common external cloud computing platforms such as Amazon Web Services (AWS) Cloud Platform, IBM Cloud Platform, Google Cloud Platform (GCP), Microsoft Azure Cloud Platform, Alibaba Cloud Platform, etc.

Referring to FIG. 1 and FIG. 3, a processor C1 and a display C2 is disposed in the terminal device C which can receive the notification information transmitted from the external computer B, and after the notification information being converted by the processer C1 into a format that is easy for operators to interpret, displayed on the display C2; the terminal device C has a built-in communication software C3 having a communication group in which members include operators, developers and the self-propelled device A. The operator (client side) is the person who operates the self-propelled device A to perform predetermined work, and the developer (development side) is a person who manufactures the self-propelled device A; the terminal device C can be one of common terminal devices such as a smartphone, a tablet computer, a laptop computer, a personal computer, etc. The communication software C3 can be, for example, one of common communication softwares such as Telegram, LINE, WeChat, Facebook Messenger, Signal, etc.

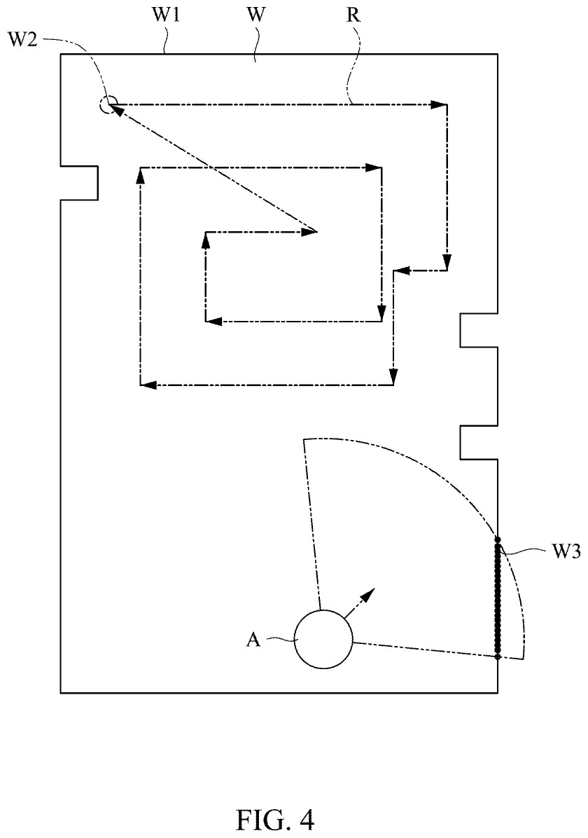

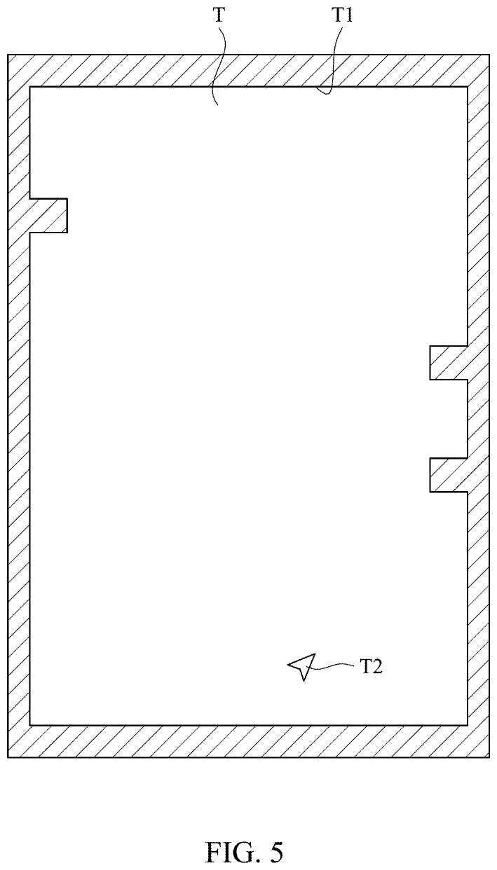

Referring to FIGS. 2, 4 and 5, the self-propelled device A can move in a workspace W, and map information T of the workspace W can be established by the sensor A1 and the internal computer A2. The workspace W has a solid structure W1 such as walls and obstacles, and has a station W2 that provides the self-propelled device A to rest. The station W2 can be a workstation such as a charging station, a maintenance station, etc. A moving direction of the self-propelled device A in the workspace W is represented by an arrow pattern, and a scanning direction and a range of the sensor A1 in the workspace W are represented by a fan-shaped pattern; when the self-propelled device A moves in the workspace W, the physical structure W1 can be scanned by the sensor A1 in front of the self-propelled device A in the workspace W and obtain a structural feature W3 (dot pattern). The structural feature W3 can be transmitted to the internal computer A2 by the sensor A1 for calculation, so that the internal computer A2 can combine the structural feature W3 obtained by the self-propelled device A after traversing the workspace W into a map information T through an algorithm and stored in the internal computer A2. The map information T has a map structure T1 (line pattern) corresponding to the physical structure W1 and a marking pattern T2 representing the position of the self-propelled device A corresponding to the workspace W. The marking pattern T2 can represent the scanning direction of the sensor A1 in an index (arrow) pattern. In the map information T, the white pattern is the movable area that is not scanned to the physical structure W1 and the oblique pattern is the immovable area that is scanned to the physical structure W1. According to the map information T, a working path R planed for cleaning, inspection, and transportation by the self-propelled device A itself. The station W2 is taken as a starting location and a ending location of the working path R. The self-propelled device A can start moving from the station W2 and then return to the station W2 after performing the predetermined work. The map structure T1 corresponds to the physical structure W1 in the workspace W, such as walls and/or obstacles as mentioned above. In some embodiments, the mapping algorithm can be, for example, graph-based simultaneous localization and mapping, so as to use the information (i.e. the shape of the physical structure and the corresponding position) obtained by the sensor A1 to establish a map. In this way, the map contains the structural features of the corresponding physical structure and the corresponding location information. For example, the walls and/or obstacles of the workspace W scanned by the sensor A1, and the corresponding shape information and the position information are obtained. Then, a map is established by the internal computer A2 based on the information collected by the sensor A1.

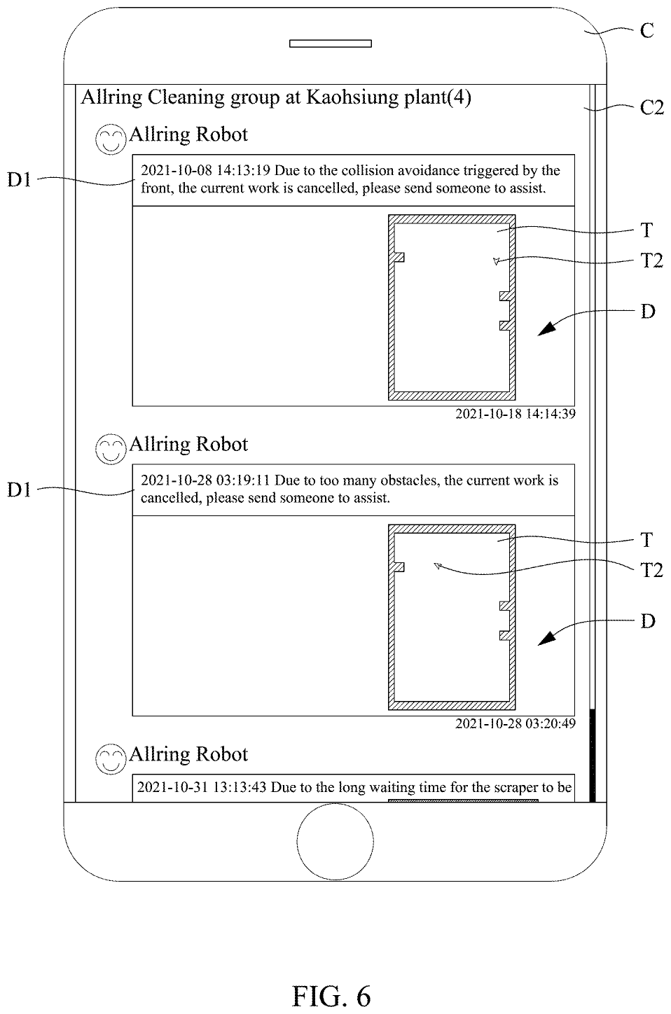

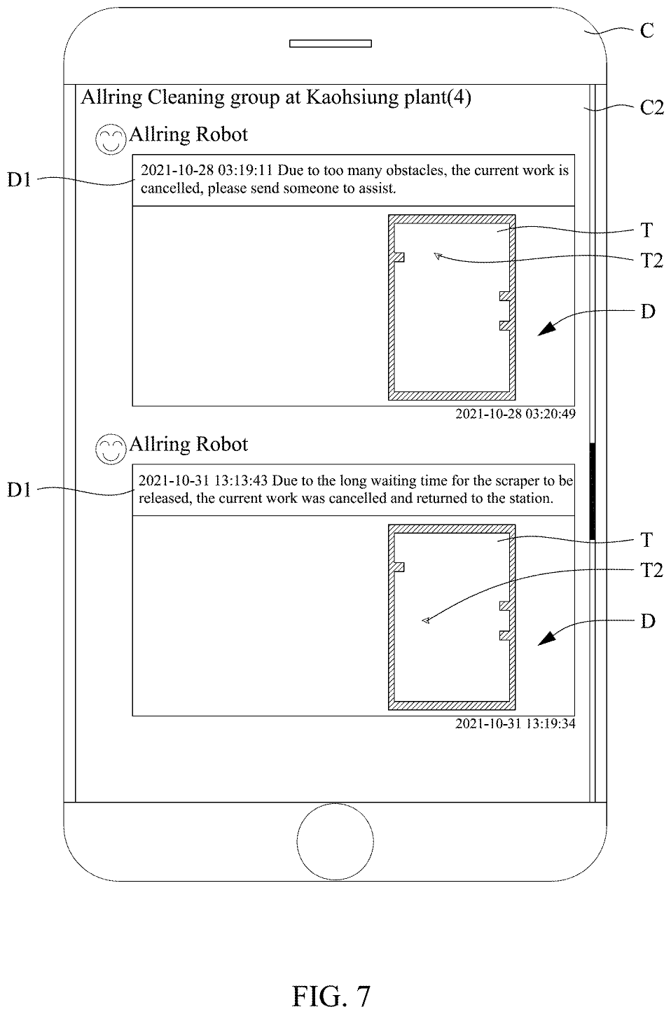

In the implementation of the method for notifying of an abnormal event, the self-propelled device and the notification system for implementing the same in accordance with the embodiment of the invention, the self-propelled device A is controlled to use the sensor A1 and the internal computer A2 to establish the map information T in the workspace W, and to plan the working path R in accordance with the map information T. The self-propelled device A moves along the working path R while unexpected abnormal events such as a collision event, an obstacle blocking event, a hardware abnormality event, etc. happens, the notification information is outputted by the internal computer A2 and displayed on the display C2; referring to FIGS. 6 and 7, a notification information D including the map information T and the marking pattern T2 in the map information T can be displayed on the display C2 of the terminal device C; the notification information D may also include a text area D1 indicating the time and a cause of the abnormal event, for example, “2021-10-08 14:13:19 Due to the collision avoidance triggered by the front, the current work is cancelled, please send someone to assist.”, “2021-10-28 03:19:11 Due to too many obstacles, the current work is cancelled, please send someone to assist.”, “2021-10-31 13:13:43 Due to the long waiting time for the scraper to be released, the current work was cancelled and returned to the station.”. The notification information D is outputted to the external computer B through a wireless network, and after being processed and stored, outputted to the terminal device C through a wireless network. The notification information D is displayed in the communication group of the communication software C3 which members include operators, developers and the self-propelled device A. When an abnormal event happens, the self-propelled device A can cancel the current work and stop moving. Then, the operator who receives the notification information D can interpret a reason for the abnormal event and the location of the abnormal event in the notification information D. It is helpful for the operator to prepare relevant tools to go to the location of the abnormal event to assist in eliminating the abnormal event. In another embodiment, the self-propelled device A can cancel the current work and directly return to the station W2 when an abnormal event happens, and the operator who receives the notification information D can interpret the reason for the abnormal event and the location of the abnormal event in the notification information D. It is helpful for the operator to know what kind of abnormal events may happen to the self-propelled device A in the workspace W. In addition, developers in the communication group can instantly know the working status of the self-propelled device A on the client side and provide operator assistance in a timely manner. The developer can also analyze the notification information D stored in the external computer B as a reference for future development and optimization.

The method for notifying of an abnormal event and the self-propelled device and the notification system for implementing the same in accordance with the embodiment of the invention, the notification information D is displayed on the display C2 of the terminal device C when an abnormal event happens to the self-propelled device A in the workspace W. The notification information D can provide the operator to interpret the corresponding position of the self-propelled device A in the workspace W, and reduce the time cost to find the self-propelled device A.

However, the descriptions are only preferred embodiments of the invention as mentioned above, and should not limit the scope of implementation of the invention. That is, any simple equivalent changes and modifications made according to the scope of the claim and the contents of the description of the invention are still within the scope of the claim of the present invention.

What is claimed is:

1. A method for notifying of an abnormal event, comprising:
providing a self-propelled device having a sensor and an internal computer;
providing a terminal device having a display and built-in communication software;
controlling the self-propelled device to use the sensor and the internal computer to establish map information in a workspace, wherein the map information corresponds to the workspace;
outputting a notification information by the internal computer when an abnormal event happens to the self-propelled device; and
displaying the notification information in a communication group of the communication software by the display, wherein the notification information includes the map information and a marking pattern of the map information indicating a corresponding position of the self-propelled device in the workspace.

2. The method for notifying of an abnormal event of claim 1, wherein the notification information includes a text area indicating the time and a cause of the abnormal event.

3. The method for notifying of an abnormal event of claim 1, wherein the self-propelled device plans a working path according to the map information, and a station is used as a starting location and a ending location of the working path, the self-propelled device moves from the station for performing a predetermined work, and return to the station after performing predetermined work, and the abnormal event happens during the movement of the self-propelled device along the working path.

4. The method for notifying of an abnormal event of claim 3, wherein the self-propelled device cancels a current work and directly returns to the station when the abnormal event occurs.

5. The method for notifying of an abnormal event of claim 3, wherein the self-propelled device cancels the current work and stops moving when the abnormal event happens.

6. The method for notifying of an abnormal event of claim 1, wherein members in the communication group include operators, developers and the self-propelled device.

7. The method for notifying of an abnormal event of claim 6, wherein the communication software system is one of Telegram, LINE, WeChat, Facebook Messenger and Signal.

8. The method for notifying of an abnormal event of claim 1, wherein the notification information is outputted to an external computer through wireless network, processed and stored by the external computer, and then outputted to the terminal device through wireless network.

9. A self-propelled device for implementing the method for notifying of an abnormal event as claimed in claim 1.

10. A self-propelled device for implementing the method for notifying of an abnormal event as claimed in claim 2.

11. A self-propelled device for implementing the method for notifying of an abnormal event as claimed in claim 3.

12. A self-propelled device for implementing the method for notifying of an abnormal event as claimed in claim 4.

13. A self-propelled device for implementing the method for notifying of an abnormal event as claimed in claim 5.

14. A self-propelled device for implementing the method for notifying of an abnormal event as claimed in claim 6.

15. A notification system for implementing the method for notifying of an abnormal event as claimed in claim 1.

16. A notification system for implementing the method for notifying of an abnormal event as claimed in claim 2.

17. A notification system for implementing the method for notifying of an abnormal event as claimed in claim 3.

18. A notification system for implementing the method for notifying of an abnormal event as claimed in claim 4.

19. A notification system for implementing the method for notifying of an abnormal event as claimed in claim 5.

20. A notification system for implementing the method for notifying of an abnormal event as claimed in claim 6.
